(19) United States
(12) Patent Application Publication
(10) Pub. No.: US 2014/0096911 A1
(43) Pub. Date: Apr. 10, 2014

(54) TAPE HOLDING WHEEL FOR A TAPE DISPENSER

(71) Applicant: Hsiu-Man YU CHEN, Taichung (TW)

(72) Inventor: Hsiu-Man YU CHEN, Taichung (TW)

(21) Appl. No.: 13/644,611

(22) Filed: Oct. 4, 2012

(51) Int. Cl. B32B 37/12

(52) U.S. Cl. 156/538

(57) ABSTRACT

A tape holding wheel for a tape dispenser, cooperating with tape rolls of various sizes, comprises a tape holding wheel, a first engaging unit, and a second engaging unit. A plurality of supporting ribs are protruded on an external cambered surface of the tape holding wheel. A propping part is integrally and laterally extended from a top end of each supporting rib, and a propping rib is axially extended on an external end of the propping part. The engaging units are disposed on the tape holding wheel for engaging a sleeve with the tape holding wheel firmly.

### FIELD OF THE INVENTION

The present invention relates to a tape holding wheel for a tape dispenser, especially to a tape holding wheel that can firmly cooperate with a tape tube for a tape dispenser.

### DESCRIPTION OF THE RELATED ART

A conventional tape dispenser mainly utilizes a tape holding wheel to cooperate with a tape roll, so that the tape can be dispensed for packaging. However, the tapes comprise so many sizes, and the central diameters of the tape tubes of the tape rolls are also different. Therefore, the tape holding wheel for the tape dispenser is provided to allow most tapes to fit the tape dispenser since the tape holding wheel is adjustable and suited to tapes of various sizes. Referring to FIG. 1, a conventional tape holding wheel for a tape dispenser comprises a tape dispenser 300 and a tape holding wheel 320. Wherein, the tape dispenser 300 mainly includes a lengthwise fixing post 304, a sleeve 305 axially placed over the fixing post 304, a plurality of parallel and protrudent rails 306 disposed on a circumference of the sleeve 305, further parallel to a central axle of the sleeve 305, so that the tape holding wheel 320 can be axially engaged with the sleeve 305 for a synchronic rotation. There is a slot 314 defined on a fore part of the sleeve 305. An axial opening 321 is defined on a center of the tape holding wheel 320, corresponding to the circumference of the sleeve 305. Inside the axial opening 321 of the tape holding wheel 320, a plurality of parallel sliding grooves 322 are defined correspondingly to the rails 306. A buckling part 323 is downwardly protruded from a rear end of the tape holding wheel 320, corresponding to the slot 314, so that the buckling part 323 can be fitly placed in the slot 314 for a convenience replacement of the tape rolls. Referring to FIG. 2, a tape holding wheel for a tape dispenser is similarly disclosed as that of afore conventional tape holding wheel for the tape dispenser. Differently, a crook 407 is protrudently installed on a fore end of the sleeve 405, and a plurality of notches 423 are defined on a circumference of a front end of the tape holding wheel 420. Thereby, the crook 407 of the sleeve 405 can be fitly placed in the notch 423 for replacing tape rolls conveniently.

Although the conventional tape holding wheels can cooperate with the tape dispenser for holding various tape rolls, the structures of afore two types of tape holding wheels are quite different. Therefore, the tape holding wheels have to cooperate with two different tape dispensers. Accordingly, it is inconvenient for users to replace the tape holding wheel in different types of tape dispensers. Moreover, the manufacturing cost of the tape holding wheel is rather high. Thus, the present invention is to provide a tape holding wheel that can be suited to different kinds of tape dispensers for achieving a convenient assemblage and decreasing the manufacturing cost.

### SUMMARY OF THE INVENTION

The object of the present invention is to provide a tape holding wheel to be fitted in different kinds of tape dispensers for achieving a convenient assemblage.

The characteristics of the tape holding wheel for a tape dispenser of the present invention are as follows:

the tape holding wheel has an axial opening defined at a center thereof; parallel sliding grooves depressed in an inner wall of the tape holding wheel are defined correspondingly to the rails of the sleeve, thereby being synchronically motivated with the sleeve; a plurality of lengthwise supporting ribs are protruded on an external cambered surface of the tape holding wheel, parallel to an axle thereof; a propping part is integrally and laterally extended from a top end of each supporting rib, toward a direction to the external cambered surface of the tape holding wheel; a propping rib is axially extended on an external end of the propping part; a guiding ramp is formed on an introducing point of the propping rib; a blocking end is outward extended from an end of the propping part; a first engaging unit is disposed on a front end of the tape holding wheel for the sleeve to firmly cooperate with the tape holding wheel; and a second engaging unit is disposed on a rear end of the tape holding wheel for the sleeve to firmly cooperate with the tape holding wheel.

Accordingly, the tape holding wheel for the tape dispenser of the present invention provides the convenient assemblage, lowers manufacturing materials, and reduces manufacturing costs. By means of the engaging units, the sleeve and the tape holding wheel can be further engaged firmly.

### BRIEF DESCRIPTION OF THE DRAWINGS

FIG. 1 is an exploded view of a conventional tape dispenser and a conventional tape holding wheel;

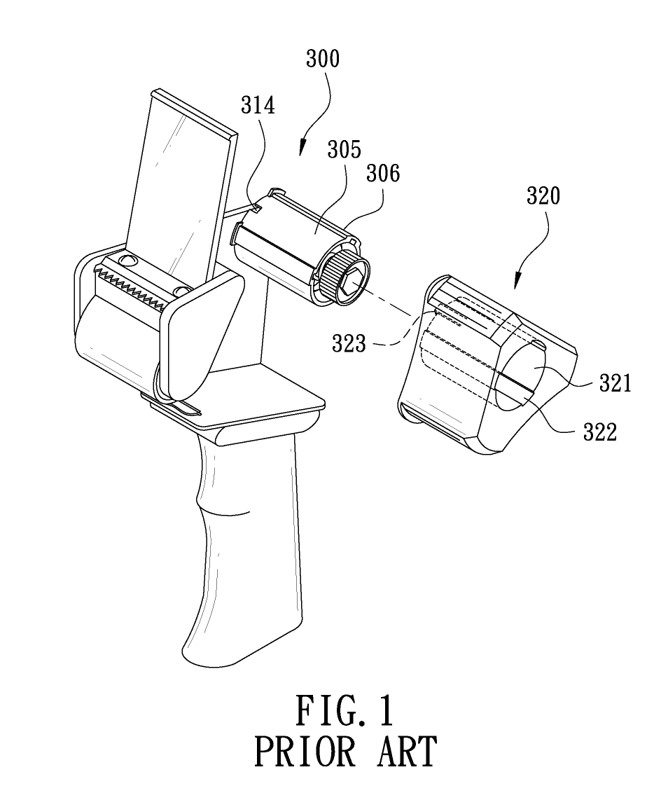

FIG. 2 is an exploded view of another conventional tape dispenser and another conventional tape holding wheel;

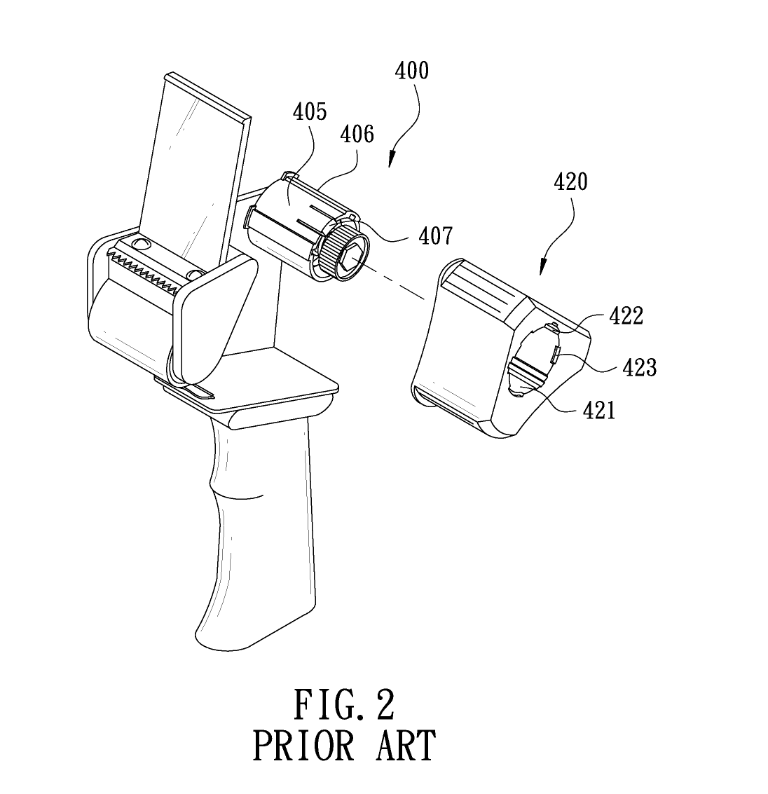

FIG. 3 is a perspective view of the present invention;

FIG. 4 is a top view of the present invention;

FIG. 5 is a cross-sectional view of section 5-5 of FIG. 4;

FIG. 6 is an exploded view of a first preferred embodiment of the present invention in using;

FIG. 7 is a partial cross-sectional view of the first preferred embodiment of the present invention in assemblage;

FIG. 8 is a top view of supporting ribs of the first preferred embodiment of the present invention having a predetermined height;

FIG. 9 is an exploded view of a second preferred embodiment of the present invention in using; and

FIG. 10 is a partial cross-sectional view of the second preferred embodiment of the present invention in assemblage.

### DETAILED DESCRIPTION OF THE PREFERRED EMBODIMENTS

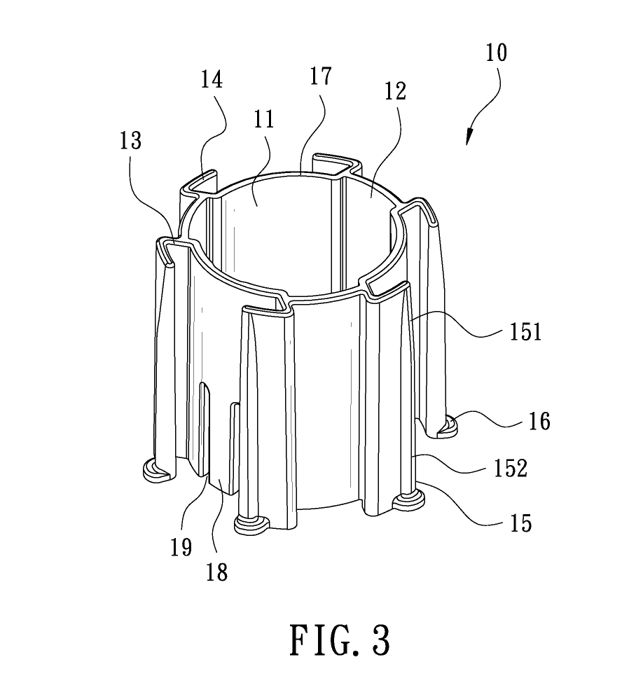

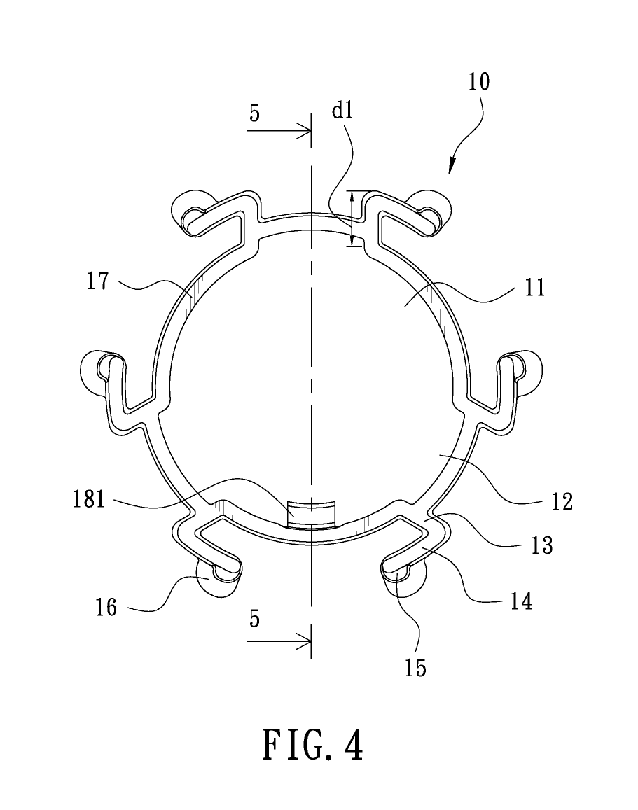

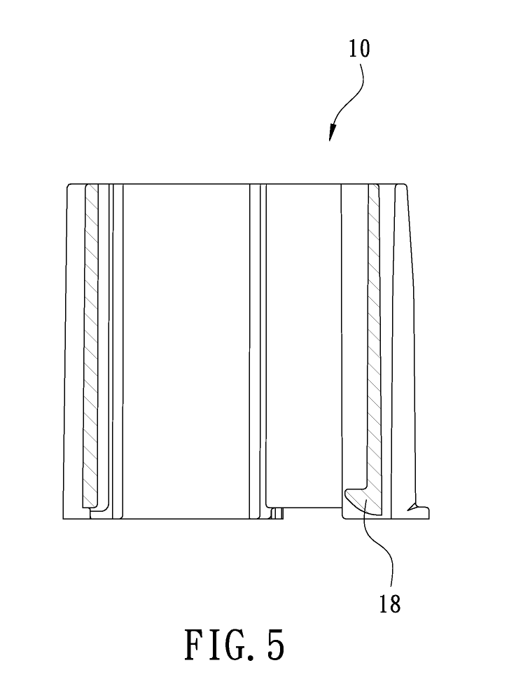

FIGS. 3, 4, and 5 show a perspective view, a top view, and a cross-sectional view of section 5-5 in FIG. 4 of the present invention. A tape holding wheel 10 is provided.

The tape holding wheel 10 has an axial opening 11 defined at a center thereof. Parallel sliding grooves 12 are depressed in an inner wall of the tape holding wheel 10, further parallel to an axle of the tape holding wheel 10. A plurality of lengthwise supporting ribs 13 are protruded on an external cambered surface of the tape holding wheel 10, further parallel to the axle thereof. The supporting ribs 13 are protruded from the external circumference of the tape holding wheel 10, corresponding to two sides of the sliding grooves 12. The supporting ribs 13 include a predetermined height d1. An arc-typed propping part 14 is integrally and laterally extended from a top end of each supporting rib 13, toward a direction to the external cambered surface of the tape holding wheel 10. One ends of the propping parts 14 are suspended from the external cambered surface of the tape holding wheel 10. Moreover, the propping parts 14 face to each other, and the propping parts 14 are extended from top ends of the supporting ribs 13, toward a direction to a middle of two sliding grooves 12. A propping rib 15 is axially extended on an external end of the propping part 14. A guiding ramp 151 is formed on an introducing point of the propping rib 15 for the tape tube to smoothly travel. Each propping rib 15 has a top end 152 formed into an arc for tightly stopping an inner wall of the tape tube. A blocking end 16 is outward extended from an end of the propping part 14. The tape holding wheel 10 also includes a first engaging unit and a second engaging unit. The first engaging unit comprises a contacting part 17 which is formed on the front end of the tape holding wheel 10. The second engaging unit comprises a reversed hook 18 which stretches inwardly from the rear end of the tape holding wheel 10. Two ripped grooves 19 in a predetermined length are defined on two sides of the reversed hook 18, respectively; a hook part of the reversed hook 18 stretches out of an inner end of the tape holding wheel 10.

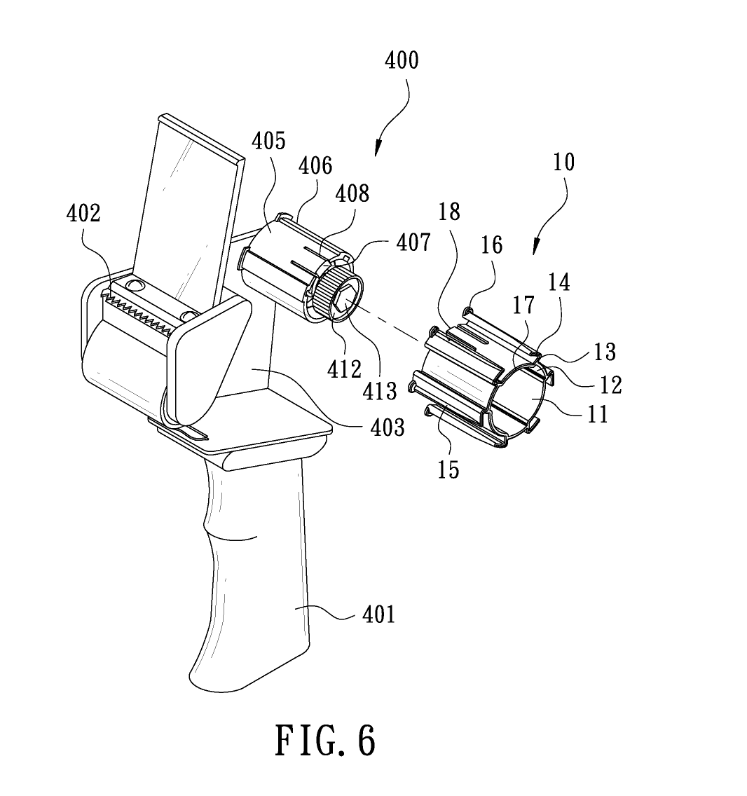

Referring to FIG. 6, a perspective view of a first preferred embodiment of the present invention is shown. Herein, the tape holding wheel 10 cooperating with a tape dispenser 400 is able to assist various tape rolls in being replaced swiftly. The tape dispenser 400 includes a handle 401 for users to handle, a saw 402 for cutting the tape, a standing board 403 fixed on aside of the handle 401, a fixing post 404 perpendicularly disposed on the standing board 403, a sleeve 405 placed over the fixing post 404, and a plurality of rails 406 parallelly protruded on an external circumference of the sleeve 405, also parallel to an axle of the sleeve 405. The rails 406 allow a tape roll of a small size to be axially engaged thereto. Further, the sliding grooves 12 of the tape holding wheel 10 are correspondingly disposed to the rails 406 on the sleeve 405, thereby allowing the tape holding wheel 10 and the sleeve 405 to be axially engaged and synchronically motivated. An outward crook 407 is protruded from a fore part end of the sleeve 405. Two ripped grooves 408 in a predetermined length are defined on two sides of the crook 407, respectively. A hook part of the crook 407 stretches out of an external part of the sleeve 405, thereby allowing the sleeve 405 and the tape holding wheel 10 to be firmly engaged with each other.

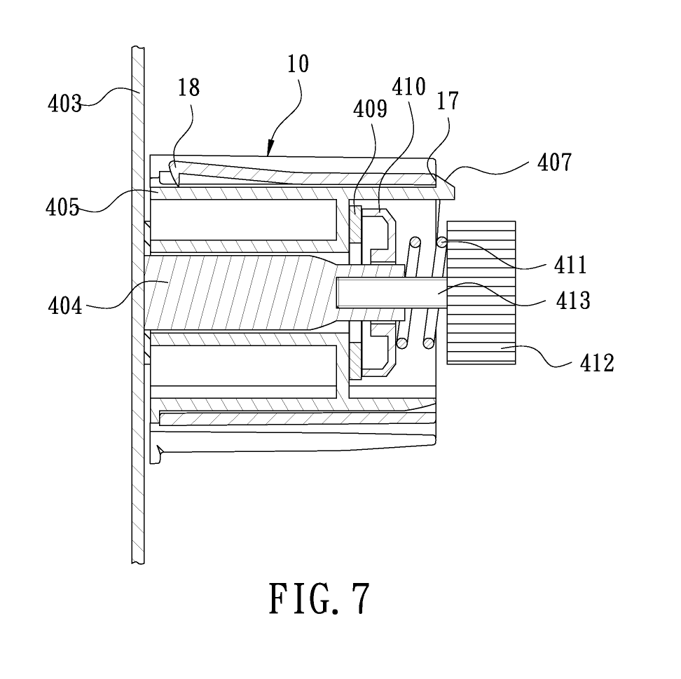

In assemblage, the sleeve 405 is placed over the fixing post 404 of the tape dispenser 400. A spacer 409, a fixing seat 410, and a spring 411 are cooperatively penetrated by the fixing post 404. A cover 412 and a screw 413 help the fixing post 404 and the sleeve 405 to be engaged with each other. As to the tape holding wheel 10, the sliding grooves 12 of the tape holding wheel 10 are aimed at the rails 406 on the sleeve 405, so that the tape holding wheel 10 is engaged with the sleeve 405. Accordingly, the crook 407 of the sleeve 405 firmly fastens the contacting part 17 of the tape holding wheel 10 as shown in FIG. 7. The first preferred embodiment of the present invention is thence provided.

In using, the tape roll is placed around the tape holding wheel 10. Herein, the guiding ramp 151 allows the tape roll to be placed smoothly. Moreover, the propping ribs 15 slightly protrude on the propping parts 14, so the propping ribs 15 will be radially pressed by the moving tape roll accordingly. Thereafter, the tape roll continues moving until it touches the blocking end 16. In the meantime, the tape roll finishes traveling, and the propping ribs 15 deform and provide bounce for tightly holding the tape roll. Accordingly, users are able to release the tape or conduct packaging through the tape dispenser 400.

When the tape holding wheel 10 is placed over the sleeve 405, the reversed hook 18 slightly protrudes out of the inner end of the tape holding wheel 10. In the meantime, the reversed hook 18 is also radially pressed by the sleeve 405. Two ripped grooves 19 in a predetermined length are defined on two sides of the reversed hook 18, respectively. Whereby, the ripped grooves 19 prevent the reversed hook 18 from over-deforming and avoid damaging.

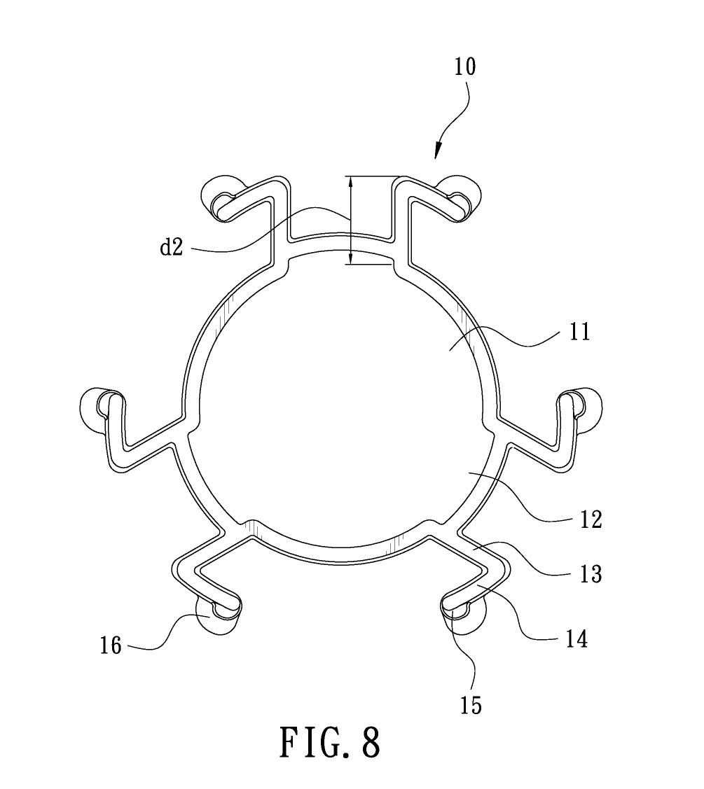

When different sizes of the tape rolls are to be applied, the crook 407 on the sleeve 405 is pressed, so that the crook 407 departs from the contacting part 17, and the tape holding wheel 10 can be taken out. Accordingly, the taken tape holding wheel 10 can be further installed in the tape dispenser 20 as shown in FIG. 8. Herein, the supporting ribs 13 on the tape holding wheel 10 comprises another predetermined height d2 for being engaged with the tape roll of a different size. Obviously, the present invention allows various tape rolls of different sizes to be replaced efficiently.

Additionally, since the propping parts 14 are formed into an arc, the arc thereof allows the tape roll to contact the propping parts 14 smoothly. The arc on the propping parts 14 also prevents the tape roll from deformation in time of releasing the tape or packaging. Therefore, the tape dispenser 20 releases the tape for packaging efficiently and smoothly. When the propping parts 14 are suspended from the external cambered surface of the tape holding wheel 10, the propping parts 14 that are axially pressed start deforming for further contacting the tape roll more firmly. Evidently, the tape holding wheel 10 of the present invention needs less manufacturing material and hence decreases correlated manufacturing costs.

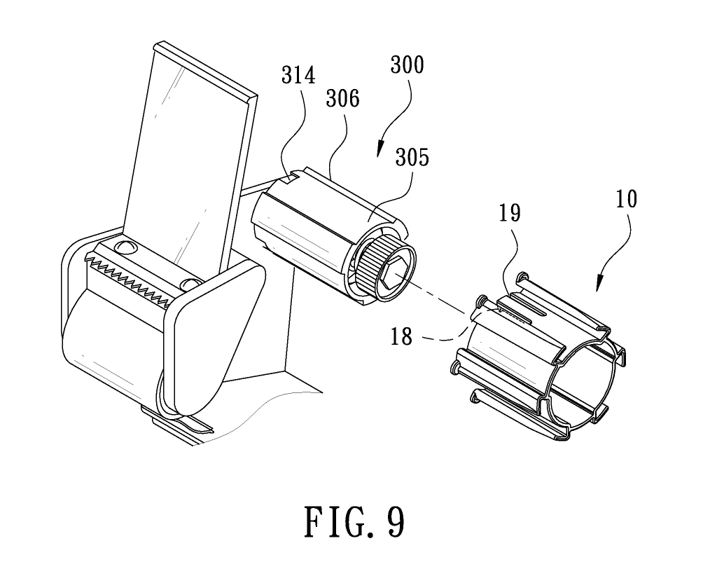

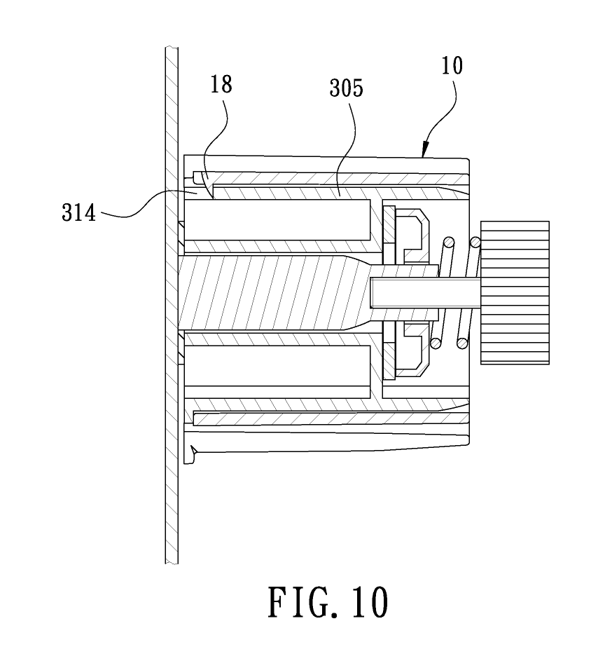

FIGS. 9 and 10 are an exploded view and a partial cross-sectional view of a second preferred embodiment of the present invention. The tape dispenser 300 applied in the second preferred embodiment is similar to that of afore preferred embodiment. Differently, at least one slot 314 is depressed on the fore part of the sleeve 305, corresponding to the reversed hook 18. In this embodiment, there are three slots 314, and the slots 314 help the sleeve 305 and the tape holding wheel 10 to be firmly engaged with other.

In assemblage of the tape holding wheel 10, the sliding slots 12 are aimed at the rails 306 on the sleeve, so that the tape holding wheel 10 is placed over the sleeve 305. Accordingly, the reversed hook 18 is able to justly slide into the slots 314 on the sleeve 305 as shown in FIG. 13, and the assemblage of the second preferred embodiment is complete.

When tape rolls of different sizes are to be applied, pulling the reversed hook 18 oppositely can release the engagement between the reversed hook 18 and the slot 314. The ripped grooves 19 at two sides of the reversed hook 18 assist users in conveniently pulling the reversed hook 18.

I claim:

1. A tape holding wheel for a tape dispenser being provided; said tape dispenser including a handle for users to hold, a standing board fixed at a side of said handle, a fixing post perpendicularly disposed on said standing board, and a sleeve superimposed on said fixing post; a plurality of parallel rails being protruded on an external circumference of said sleeve and parallel to an axle of said sleeve; said rails being able to axially engaged with a tape of a small dimension; said sleeve of said tape dispenser being further superimposed by a tape holding wheel; said tape holding wheel being able to axially engaged with a tape of a large dimension;
wherein, said tape holding wheel has an axial opening defined at a center thereof; parallel sliding grooves depressed in an inner wall of said tape holding wheel being defined correspondingly to said rails of said sleeve, thereby being synchronically motivated with said sleeve; a plurality of lengthwise supporting ribs being protruded on an external cambered surface of said tape holding wheel, parallel to an axle thereof; a propping part being integrally and laterally extended from a top end of each supporting rib, toward a direction to said external cambered surface of said tape holding wheel; a propping rib being axially extended on an external end of said propping part; a guiding ramp being formed on an introducing point of said propping rib; a blocking end being outward extended from an end of said propping part;
a first engaging unit being disposed on a front end of said tape holding wheel for said sleeve to firmly cooperate with said tape holding wheel; and
a second engaging unit being disposed on a rear end of said tape holding wheel for said sleeve to firmly cooperate with said tape holding wheel.

2. The tape holding wheel as claimed in claim 1, wherein, an outward crook is protruded from a fore part of said sleeve; two ripped grooves in a predetermined length are defined on two sides of said crook, respectively; a hook part of said crook stretches out of an external part of said sleeve; said first engaging unit comprises a contacting part which is formed on said front end of said tape holding wheel, corresponding to said crook.

3. The tape holding wheel as claimed in claim 2, wherein, said second engaging unit comprises a reversed hook which stretches inwardly from said rear end of said tape holding wheel; two ripped grooves in a predetermined length are defined on two sides of said reversed hook, respectively; a hook part of said reversed hook stretches out of an inner end of said tape holding wheel.

4. The tape holding wheel as claimed in claim 1, wherein, said second engaging unit comprises a reversed hook which stretches inwardly from said rear end of said tape holding wheel; two ripped grooves in a predetermined length are defined on two sides of said reversed hook, respectively; a hook part of said reversed hook stretches out of an inner end of said tape holding wheel; at least one depressed slot is defined on a fore part of said sleeve, corresponding to said reversed hook.

5. The tape holding wheel as claimed in claim 1, wherein, said supporting ribs are protruded from said external circumference of said tape holding wheel, corresponding to two sides of said sliding grooves.

6. The tape holding wheel as claimed in claim 1, wherein, said propping parts are formed into an arc.

7. The tape holding wheel as claimed in claim 1, wherein, said propping parts face to each other; said propping parts are extended from top ends of said supporting ribs toward a direction to a middle of two sliding grooves.

8. The tape holding wheel as claimed in claim 1, wherein, said propping rib is outward extended from said external end of each propping part.

9. The tape holding wheel as claimed in claim 1, wherein, each propping rib has a top end formed into an arc.
